(19) United States
(12) Patent Application Publication
(10) Pub. No.: US 2012/0124323 A1
(43) Pub. Date: May 17, 2012

(54) METHOD FOR SETTING MEMORY ADDRESS SPACE

(75) Inventors: Ying-Chih Lu, Taipei City (TW); Yu-Hui Wang, Taipei City (TW)

(73) Assignee: INVENTEC CORPORATION, Taipei City (TW)

(21) Appl. No.: 13/159,783

(22) Filed: Jun. 14, 2011

(30) Foreign Application Priority Data
Nov. 12, 2010 (TW) 99139037

(51) Int. Cl. G06F 12/06

(52) U.S. Cl. 711/202; 711/E12.078

(57) ABSTRACT

A method for setting a memory address space is provided. A memory access frequency of an application program is obtained under execution of an operating system (OS). And a mapping of a memory region is decided according to the memory access frequency. Next, an interrupt signal is used for executing an interrupt handler routine. The mapping of the memory region is set under execution the interrupt handler routine. And the application program is loaded into the memory region for executing in the OS.

### CROSS-REFERENCE TO RELATED APPLICATION

This application claims the priority benefit of Taiwan application serial no. 99139037, filed Nov. 12, 2010. The entirety of the above-mentioned patent application is hereby incorporated by reference herein and made a part of this specification.

### BACKGROUND

1. Field of the Invention

The invention relates to a memory mapping method. Particularly, the invention relates to a method for dynamically setting a memory address space.

2. Description of Related Art

In a multi-processor system, a basic input output system (BIOS) can only set two memory address space mapping modes of a non-uniform memory access (NUMA) mode and a uniform memory access (UMA) mode. In the UMA mode, a time for each processor accessing any memory module is the same, and in the NUMA mode, a time for each processor accessing a memory module closed to the processor is faster than accessing other memory modules.

If the UMA mode is used on a memory structure, processor extensibility is limited by a memory bandwidth. If the NUMA mode is used, the problem that the processor extensibility is limited by the memory bandwidth is decreased, though a local processor may spend more time to access an external memory, and consistency of cache data has to be maintained. The NUMA mode may use a local memory and the external memory, the local memory is a memory on a same node with a processor with a currently executed thread, and the memory not belonged to the node of the currently executed thread is the external memory. Therefore, in the NUMA mode, it may take longer time for accessing some memory regions than other regions. Therefore, it seems that the system cannot achieve an optimal performance by only selecting to use the UMA mode or the NUMA mode through the BIOS.

### SUMMARY OF THE INVENTION

The invention is directed to a method for setting a memory address space, by which a system may change a mapping method according to different requirements.

The invention provides a method for setting a memory address space. The method for setting a memory address space is suitable for an electronic apparatus. A memory access frequency of an application program is obtained under execution of an operating system (OS). And mapping of a memory region is decided according to the memory access frequency. Next, an interrupt signal is used to execute an interrupt handler routine. The mapping of the memory region is set according to a memory mapping mode under execution of the interrupt handler routine. The application program is loaded into the memory region for executing in the OS.

In an embodiment of the invention, in the step of obtaining the memory access frequency of the application program, a header of the application program is read to determine whether the application program is executed based on a processor computation or a memory accessing operation or a combination thereof, so as to obtain the memory access frequency.

In an embodiment of the invention, in the step of obtaining the memory access frequency of the application program, the memory access frequency is obtained from historical data of the application program. For example, execution times of activating a memory cycle during each execution of the application program and an execution time thereof are recorded. Moreover, the memory access frequency is calculated according to the execution times and the execution time. After execution of the application program is completed, the memory access frequency and a global unique identifier (GUID) of the application program are stored as the historical data corresponding to the application program in a parameter memory.

In an embodiment of the invention, in the step of setting the mapping of the memory region according to the memory mapping mode under execution of the interrupt handler routine, the memory region and a related setting of the memory region are obtained, and the related setting of the memory region is set into a chipset register.

In an embodiment of the invention, after the step of setting the mapping of the memory region according to the memory mapping mode under execution of the interrupt handler routine, a memory mapping data is generated. In the operating system, the memory mapping data is read so as to load the application program to the corresponding memory region.

In an embodiment of the invention, the mapping of the memory region is a uniform memory access (UMA) mode or a non-uniform memory access (NUMA) mode.

In an embodiment of the invention, during a power on self test (POST) process, a system memory physical topology is provided. The system memory physical topology includes a memory subsystem configuration and a memory topology structure. The memory subsystem configuration records a number of sockets, a number of channels corresponding to each of the sockets, and a number of memory modules corresponding to each of the channels. The memory topology structure records a relationship among a socket, a central processor thread, a channel, a memory module and a rank. Under execution of the operating system, the system memory physical topology is read.

According to the above descriptions, the system may change a mapping method according to different requirements, so that the operating system can freely and dynamically change the mapping of the memory address space, so as to achieve a better system performance.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the invention.

FIG. 2 is a flowchart illustrating a method for setting a memory address space according to an embodiment of the invention.

FIG. 3 is a schematic diagram illustrating a historical data of an application program according to an embodiment of the invention.

FIG. 4 is a schematic diagram illustrating a system memory structure according to an embodiment of the invention.

FIG. 5 is a schematic diagram illustrating a memory subsystem configuration according to an embodiment of the invention.

FIG. 6 is a schematic diagram illustrating a memory topology structure before mapping according to an embodiment of the invention.

FIG. 7 is a schematic diagram illustrating a memory region configuration according to an embodiment of the invention.

FIG. 8 is a schematic diagram illustrating a memory topology structure after mapping according to an embodiment of the invention.

FIG. 9 is a schematic diagram of a memory mapping data according to an embodiment of the invention.

FIG. 10 is a schematic diagram illustrating a setting of a chipset register according to an embodiment of the invention.

### DETAILED DESCRIPTION OF DISCLOSED EMBODIMENTS

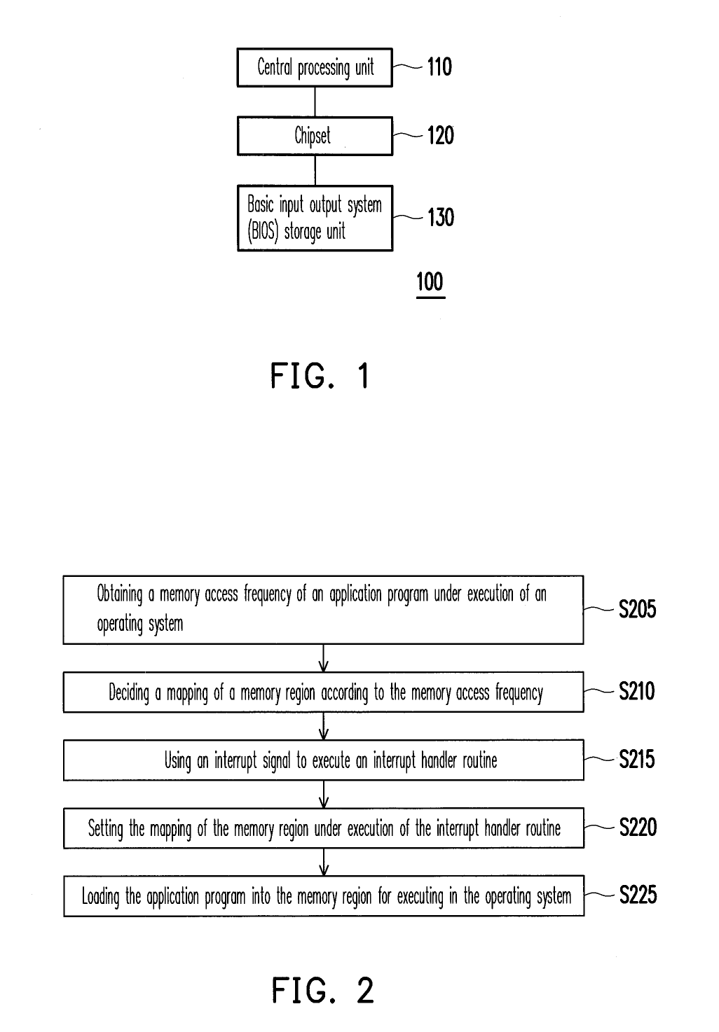

FIG. 1 is a block diagram illustrating an electronic device according to an embodiment of the invention. Referring to FIG. 1, the electronic device 100 includes a central processing unit (CPU) 110, a chipset 120 and a basic input output system (BIOS) storage unit 130. The chipset 120 is, for example, a south bridge chip or a north bridge chip, or a south and north bridge chipset, which is coupled to the CPU 110 and the BIOS storage unit 130. The BIOS storage unit 130 is used for storing program codes of the BIOS. A method for setting a memory address space is described in detail below with reference of the electronic device 100.

FIG. 2 is a flowchart illustrating a method for setting a memory address space according to an embodiment of the invention. In the present embodiment, an operating system (OS) measures a current optimal mapping of the system memory address space in an overall consideration, and accordingly provides a mapping requirement of the memory address space to the BIOS, and after the BIOS completes setting the mapping, the BIOS reports a result to the OS. Then, the OS loads an application program, for example, a process or a thread into a memory region of the required memory address space for executing.

Referring to FIG. 2, in step S205, the CPU 110 executes the OS, so as to obtain a memory access frequency of the application program under execution of the OS. For example, the OS can read a header of the application program to determine whether the application program is executed based on a processor computation or a memory accessing operation or a combination thereof, so as to obtain the memory access frequency. Namely, when the application program is executed based on the processor computation, a chance of using a memory module is relatively low, which represents that it has a low memory access frequency. When the application program is executed based on the memory accessing operation, a chance of using the memory module is relatively high, which represents that it has a high memory access frequency.

Moreover, a historical data of the application program can be recorded, and the memory access frequency of the application program can also be determined according to the historical data. For example, execution times of activating a memory cycle during each execution of the application program and an execution time thereof are recorded. Moreover, the memory access frequency is calculated according to the execution times and the execution time. After execution of the application program is completed, the memory access frequency and a global unique identifier (GUID) of the application program are stored as the historical data corresponding to the application program in a parameter memory (for example, a non-volatile random access memory (NVRAM)). In this way, when the OS executes the application program for the next time, the historical data stored in the parameter memory can be obtained according to the GUID of the application program.

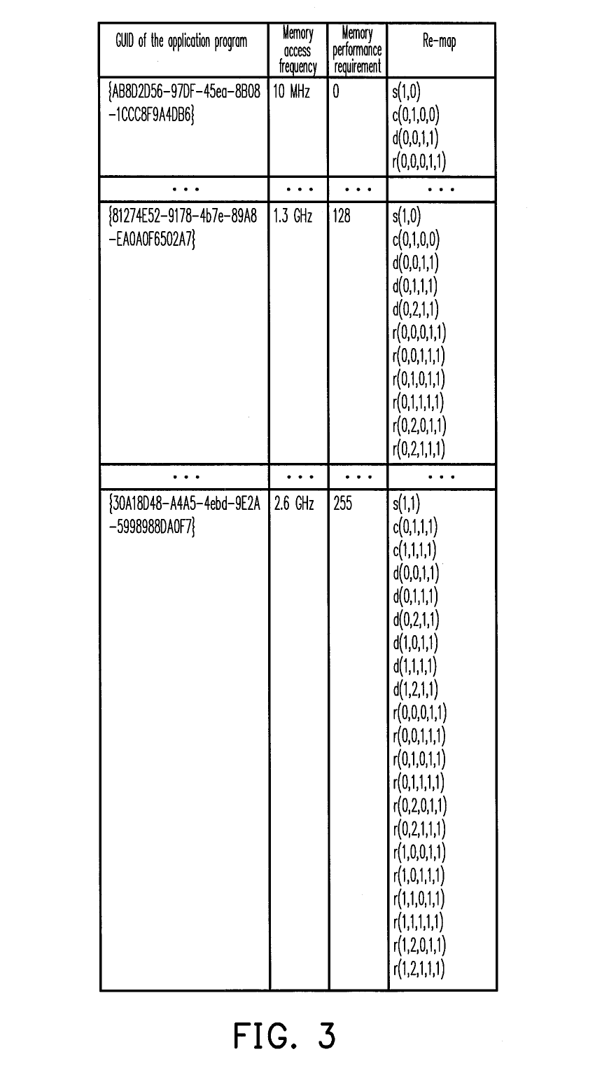

For example, FIG. 3 is a schematic diagram illustrating the historical data of the application program according to an embodiment of the invention. In FIG. 3, a table used for recording the historical data of the application program is illustrated, which includes four fields for respectively recording the GUID of the application program, the memory access frequency, the memory performance requirement and address allocation of re-mapping. The memory performance requirement corresponds to the memory access frequency, and the higher the memory access frequency is, the higher the memory performance requirement is. In the field of the memory performance requirement, a range of the memory performance requirement is 0-255, and the higher the numeral is, the higher the memory access frequency is, so that during a mapping process, the memory region with higher memory access frequency has higher interleaving. In the re-mapping field, s represents a socket ratio, c represents a channel ratio, d represents a memory module ratio, and r represents a rank ratio. The socket ratio is represented by s(s0, s1), the channel ratio is represented by c(s#, c0, c1, c2), the memory module ratio is represented by d(s#, c#, d0, d1), and the rank ratio is represented by (s#, c#, d#, r0, r1), where s# is a socket ID, c# is a channel ID, and d# is a memory module ID.

Then, in step S210, the OS selects a mapping of a memory region according to the memory access frequency. Generally, when the application program enters the system and requires a memory address space, the OS may find and assign an available space to the application program for utilization. In the present embodiment, the OS can select a memory region according to the memory access frequency, and decides a mapping mode of the selected memory region according to the memory access frequency of the application program, for example, a uniform memory access (UMA) mode or a non-uniform memory access (NUMA) mode.

In detail, during a booting process, the BIOS may provide a system memory physical topology. For example, when the BIOS executes a power on self test (POST), the BIOS provides the system memory physical topology. Before the OS executes the application program, the OS reads the system memory physical topology. Therefore, the OS can find the suitable memory region and the corresponding mapping mode from the system memory physical topology according to the memory access frequency of the application program.

The system memory physical topology includes a memory subsystem configuration and a memory topology structure. To ensure that the OS reads the system memory physical topology, a method can be designed for being called by the OS. For example, a method SMPT can be designed according to an ACPI (advanced configuration and power interface) machine language (AML) program, which has an input parameter and an output parameter. Moreover, it can be designed as that when the input parameter is 0, the memory subsystem configuration can be read, when the input parameter is 1, the memory topology structure before the mapping can be read, and when the input parameter is 2, the memory topology structure after the mapping can be read. The memory subsystem configuration records a number of sockets, a number of channels corresponding to each of the sockets, and a number of memory modules corresponding to each of the channels. The memory topology structure records a relationship among the sockets, CPU threads, the channels, the memory modules and the ranks.

An embodiment is provided below to describe the system memory physical topology.

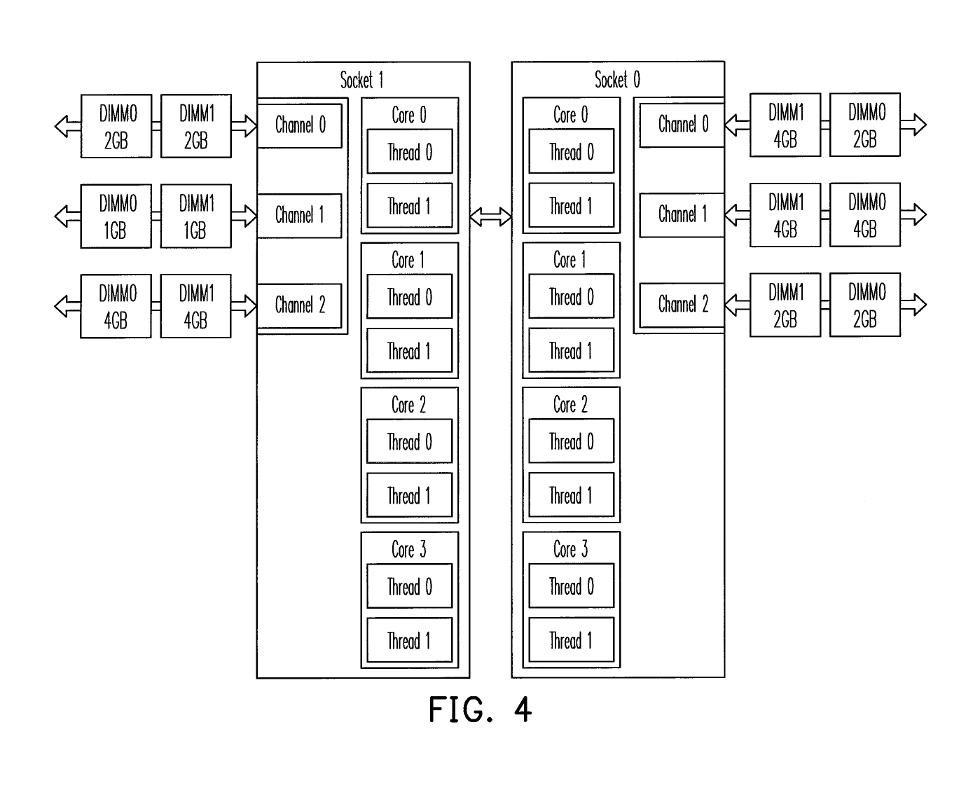

FIG. 4 is a schematic diagram illustrating a system memory structure according to an embodiment of the invention. In the present embodiment, the structure is a multi-processor system, in which a socket 0 and a socket 1 respectively represent different processors. The socket 0 and the socket 1 respectively have three channels, and two memory modules are respectively configured on each of the channels. Here, the memory module is a dual inline memory module (DIMM). Namely, the socket 0 includes a channel 0, a channel 1 and a channel 2, and the three channels respectively have a DIMM 0 and a DIMM 1. Moreover, the socket 1 also includes the channel 0, the channel 1 and the channel 2, and the three channels respectively have the DIMM 0 and the DIMM 1. In addition, the socket 0 and the socket 1 respectively have 4 cores, and each core includes two threads.

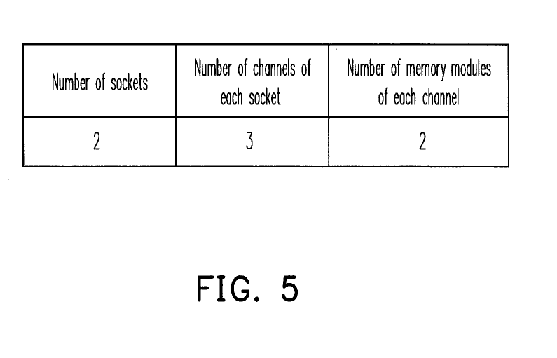

FIG. 5 is a schematic diagram illustrating a memory subsystem configuration according to an embodiment of the invention. In the present embodiment, the system memory structure of FIG. 4 is taken as an example. Referring to FIG. 5, the memory subsystem configuration includes two sockets, each socket has three channels, and each channel has two memory modules.

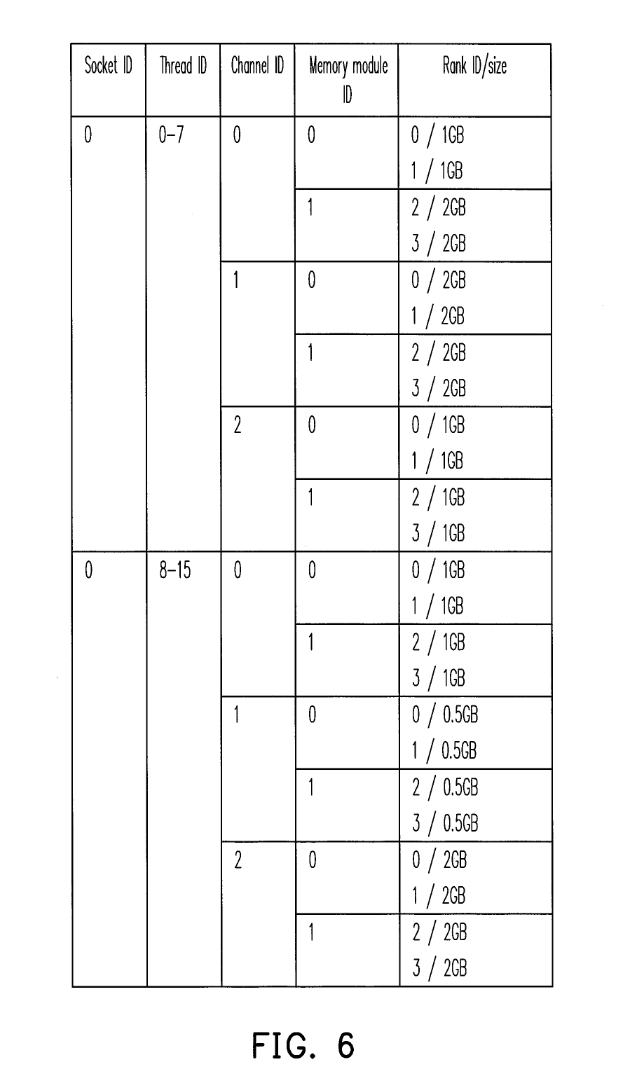

FIG. 6 is a schematic diagram illustrating a memory topology structure before mapping according to an embodiment of the invention. In the present embodiment, the memory topology structure records sizes of the ranks of the memory modules before mapping. Referring to FIG. 6, the structure of FIG. 4 is taken as an example, assuming IDs (local APIC IDs) of the threads on the socket 0 are 0-7, and local APIC IDs on the socket 1 are 8-15. The number of the rank of each of the memory modules is 2. Rank IDs of the DIMM 0 of each channel are respectively 0 and 1, and rank IDs of the DIMM 1 are respectively 2 and 3. Regarding the socket 0 in the structure of FIG. 4, the DIMM 0 and the DIMM 1 of the channel 0 of the socket 0 are respectively 2 GB and 4 GB, where a size assigned to each of the rank IDs 0 and 1 of the DIMM 0 is 1 GB, and a size assigned to each of the rank IDs 2 and 3 of the DIMM 1 is 2 GB, and the others are deduced by analogy.

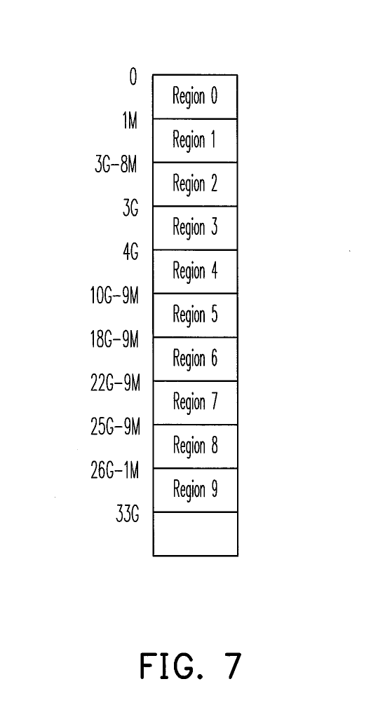

FIG. 7 is a schematic diagram illustrating a memory region configuration according to an embodiment of the invention. Referring to FIG. 7, it is assumed that the memory address space is configured into 10 memory regions, i.e. a region 0 to a region 9. A range of the region 0 is 0˜(1 M-1), a range of the region 1 is 1M˜(3 G-8 M-1), a range of the region 2 is (3 G-8 M)˜(3 G-1), a range of the region 3 is 3 G˜(4 G-1), a range of the region 4 is 4 G˜(10 G-9 M-1), a range of the region 5 is (10 G-9 M)˜(18 G-9 M-1), a range of the region 6 is (18 G-9 M)˜(22 G-9 M-1), a range of the region 7 is (22 G-9 M)˜(25 G-9 M-1), a range of the region 8 is (25 G-9 M)˜(26 G-1 M-1), and a range of the region 9 is (26 G-1 M)˜(33 G-1 M-1).

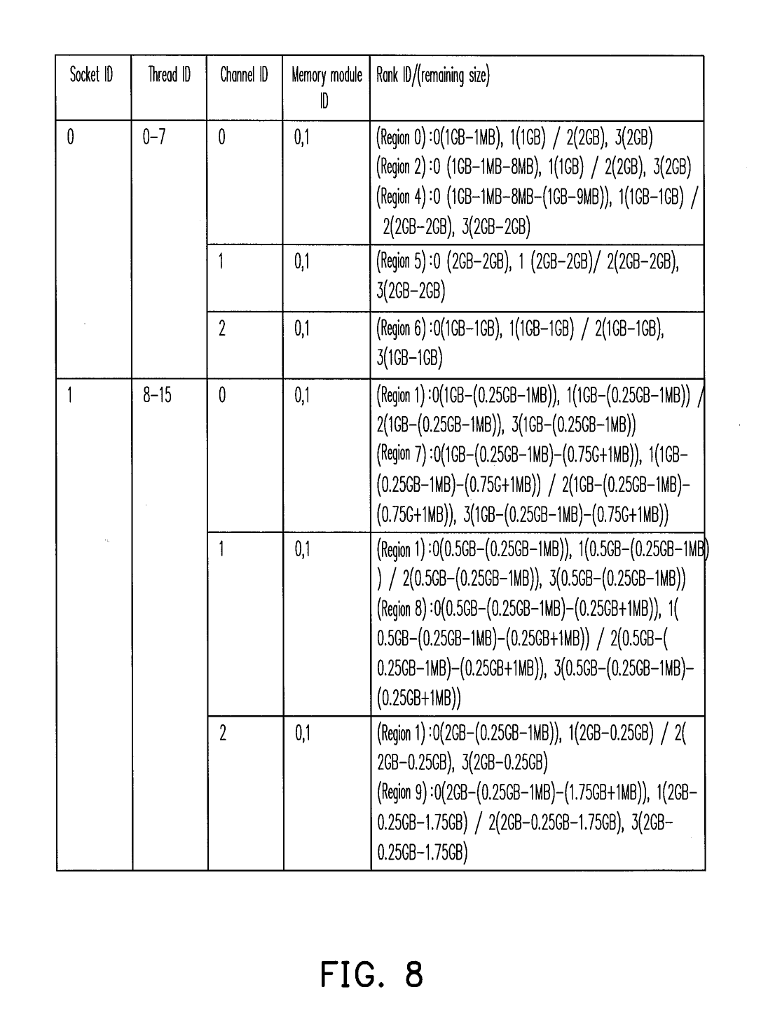

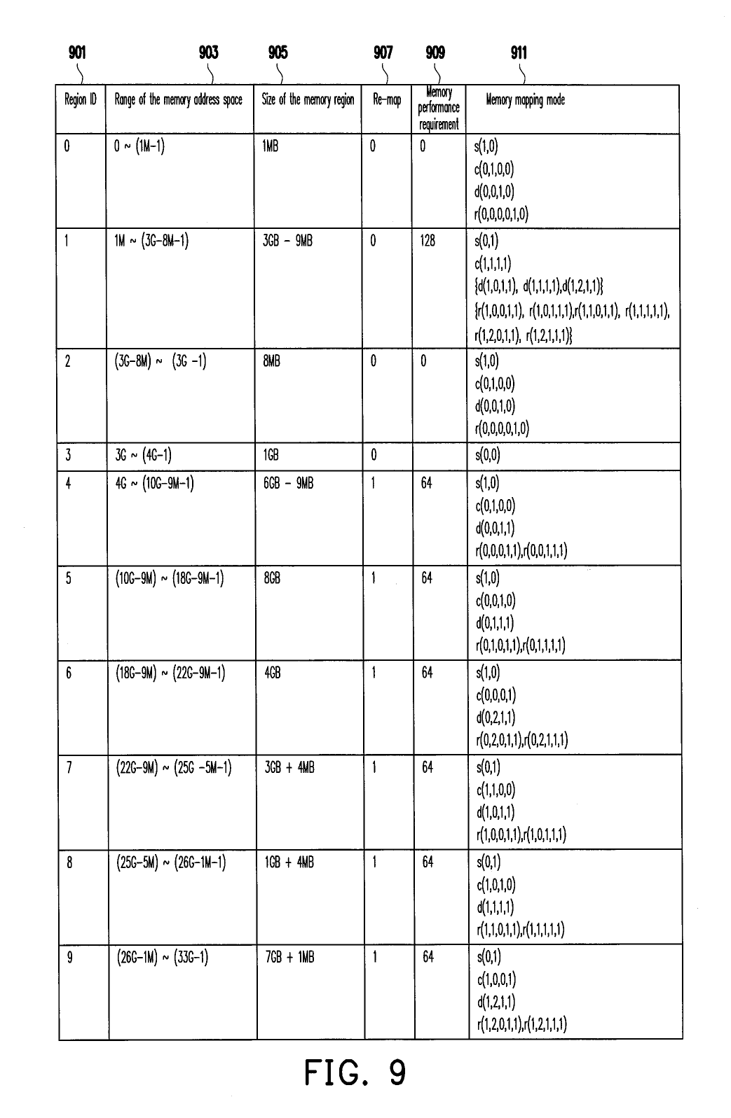

Based on the structure of FIG. 4 and the region configuration of FIG. 7, another embodiment is provided below to describe a configuration of the memory after mapping. FIG. 8 is a schematic diagram illustrating a memory topology structure after mapping according to an embodiment of the invention. FIG. 9 is a schematic diagram of a memory mapping data according to an embodiment of the invention.

Referring to FIG. 8, which records the memory topology structure after the mapping, i.e. respective positions of the region 0 to the region 9 of FIG. 7. Regarding a configuration position “(0(1 GB-1 MB), 1(1 GB)/2(2 GB), 3(2 GB)” of the region 0, in which “0(1 GB-1 MB), 1(1 GB)” represents the rank ID 0 and the rank ID 1 under the DIMM 0 of the channel 0 of the socket 0, and “2(2 GB), 3(2 GB)” represents the rank ID 2 and the rank ID 3 under the DIMM 1 of the channel 0 of the socket 0. A remaining size of the rank ID 0 is (1 GB-1 MB), a remaining size of the rank ID 1 is 1 GB, a remaining size of the rank ID 2 is 2 G, and a remaining size of the rank ID 3 is 2 G. Therefore, it is known that the region 0 is configured in the channel 0 under the socket 0, and in the rank ID 0 under the DIMM 0 connected to the channel 0, and a configuration size thereof is 1 MB, so that the remaining size is (1 GB-1 MB). Configuration positions of the other regions can be deduced by analogy. The memory mapping data can be obtained according to FIG. 8, which is shown in FIG. 9.

Referring to FIG. 9, a field 901 records the region ID of each of the memory regions, a field 903 records the range of the memory address space of each of the memory regions, a field 905 records the size of each of the memory regions, a field 907 records whether each of the memory regions can be remapped, a field 909 records the memory performance requirement of each of the memory regions, and a field 911 records the memory mapping mode of each of the memory regions.

In the field 907, 0 represents that the memory region cannot be remapped, and 1 represents that the memory region can be remapped. In the field 909, a range of the memory performance requirement is, for example, 0-255, and the higher the numeral is, the higher frequency the memory region is accessed, so that during a mapping process, the memory region with higher memory performance requirement has higher interleaving.

In the field 911, the memory mapping mode of each memory region includes a socket ratio, a channel ratio, a memory module ratio and a rank ratio, i.e. ratios for mapping the memory region to different sockets, channels, memory modules and ranks. The socket ratio is represented by s(s0, s1), the channel ratio is represented by c(s#, c0, c1, c2), the memory module ratio is represented by d(s#, c#, d0, d1), and the rank ratio is represented by r(s#, c#, d#, r0, r1), where s# is a socket ID, c# is a channel ID, and d# is a memory module ID.

A size of the memory region of the region 0 is 1 MB. In the memory mapping mode of the region 0, s(1, 0) represents that a configuration ratio of the socket 0 and the socket 1 is 1:0, i.e. the region 0 is all configured in the socket 0. c(0, 1, 0, 0) represents that a configuration ratio of the channel 0, the channel 1 and the channel 2 under the socket 0 is 1:0:0, i.e. the region 0 is all configured under the channel 0 of the socket 0. Moreover, d(0, 0, 1, 0) represents that a configuration ration of the DIMM 0 and the DIMM 1 of the channel 0 under the socket 0 is 1:0, i.e. the region 0 is all configured in the DIMM 0 under the channel 0 of the socket 0. r(0, 0, 0, 0, 1, 0) represents that a rank ratio of the DIMM 0 under the channel 0 of the socket 0 is 1:0, i.e. the region 0 is configured in the rank 0 of the DIMM 0 under the channel 0 of the socket 0, which is represented by (S0, C0, D0, R0). Descriptions of the memory mapping mode of the other regions can be deduced by analogy, which are not repeated herein. Generally, an initial region (i.e. the region 0) of the memory address space is used by the BIOS and the OS, which cannot be remapped, so that the field 907 thereof is recorded as 0.

A size of the memory region of the region 1 is (3 GB-9 MB), which is generally used to store program codes of the OS, so that it cannot be remapped. The region 1 is evenly distributed to (S1, C0/C1/C2, D0/D1, R0/R1). A size of the memory region of the region 2 is 8 MB, which is generally used as a system management mode (SMM) memory of the BIOS, so that it cannot be remapped. The region 2 is evenly distributed to (S0, C0, D0, R0). A size of the memory region of the region 3 is 1 GB, which is generally used by a memory-mapped I/O (MMIO), so that such region is not mapped. A size of the memory region of the region 4 is (6 GB-9 MB), which is evenly distributed in the channel 0 of the socket 0. A size of the memory region of the region 5 is 8 GB, which is evenly distributed in the channel 1 of the socket 0. A size of the memory region of the region 6 is 4 GB, which is evenly distributed in the channel 2 of the socket 0. A size of the memory region of the region 7 is (3 GB+4 MB), which is evenly distributed in the channel 0 of the socket 1. A size of the memory region of the region 8 is (1 GB+4 MB), which is evenly distributed in the channel 1 of the socket 1. A size of the memory region of the region 9 is (7 GB+1 MB), which is evenly distributed in the channel 2 of the socket 1.

In this way, after the OS reads the system memory physical topology, the OS selects one of the memory regions from the memory mapping data according to the memory performance requirement of the application program.

Then, in step S215, an interrupt signal is used to execute an interrupt handler routine. For example, the OS can set the mapping of the memory region through a software system management interrupt (SW SMI). The OS can trigger the SMI to the CPU 110 through the chipset 120 (for example, a south bridge chip). When the SMI is triggered to the CPU 110, the CPU 110 enters a system management mode (SMM). The CPU 110 can read a SMI handler routine from a system management random access memory (SMRAM) under the SMM, so as to serve the SMI through the SMI handler routine.

Then, in step S220, under execution of the interrupt handler routine, the interrupt handler routine sets the mapping of the memory region. For example, the interrupt handler routine obtains the memory region and a related setting of the memory region. Then, the interrupt handler routine sets the related setting of the memory region into a chipset register. After the setting is completed, the memory mapping data is generated, and a RSM command is executed to quit the SMM.

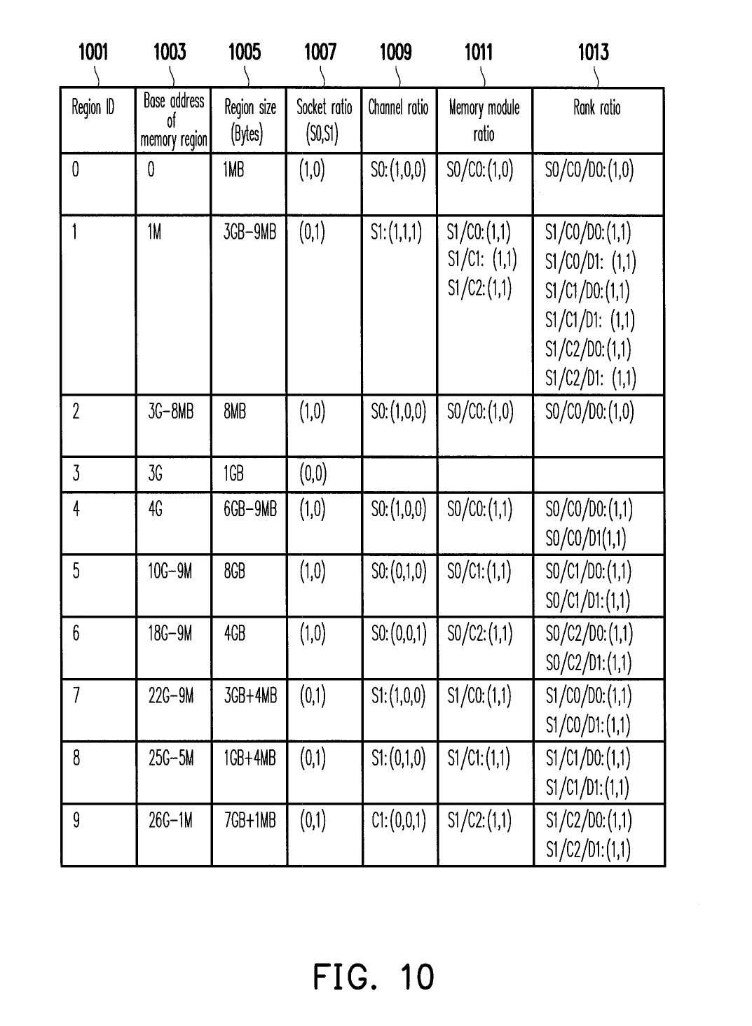

FIG. 10 is a schematic diagram illustrating a setting of a chipset register according to an embodiment of the invention. Referring to FIG. 10, a field 1001 records the region ID of each of the memory regions, a field 1003 records a base address of each of the memory regions, a field 1005 records a size (with a unit of byte) of each of the memory regions, and a field 1007, a field 1009, a field 1011 and a field 1013 respectively record the socket ratio, the channel ratio, the memory module ratio and the rank ratio of each of the memory regions.

In the field 1007, the socket ratio occupies 4n bits i.e. 2×2×n=4n bits, where n is a bit number of each socket ratio. Fore example, n=3 represents that a value of each socket ratio is 0-7, so that the socket ratio occupies 1.5 bytes. In the field 1009, the channel ratio occupies 6n bits, i.e. 2×3×n (2 bytes plus 2 bits), S0 represents the channel ratio of the socket 0, and S1 represents the channel ratio of the socket 1. In the field 1011, the memory module ratio occupies 12n bits (4.5 bytes), i.e. 2×3×2n, “S0/C0” represents the memory module ratio of the channel 0 of the socket 0, “S0/C1” represents the memory module ratio of the channel 1 of the socket 0, “S0/C2” represents the memory module ratio of the channel 2 of the socket 0, “S1/C0” represents the memory module ratio of the channel 0 of the socket 1, “S1/C1” represents the memory module ratio of the channel 1 of the socket 1, and “S1/C2” represents the memory module ratio of the channel 2 of the socket 1. In the field 1013, the rank ratio occupies 24n bits (9 bytes), i.e. 2×3×2×2×n, and “S#/C#/D#” represents the rank ratio in a certain memory module of a certain channel under a certain socket.

In the present embodiment, to ensure that the OS can read the memory mapping data, a method can be designed for being called by the OS. When the OS calls the method, the SMI is triggered to execute the SMI handler routine. For example, the AML program is used to design a method SCAM to obtain the memory mapping data. After obtaining the memory mapping data, the OS can obtain a mapping status of the memory regions, so as to load the application program to a suitable memory region to achieve better system performance. Namely, the OS can use the method SCAM to allocate or release the mapping of the memory address space. The OS can input the base address and the size of the selected memory region, and a parameter (for example, 0 represents release and 1 represents allocate) used for determining to allocate or release the memory region into the method. When the mapping of the memory region is to be set, the mapping of the memory region is set according to the socket ratio, the channel ratio, the memory module ratio and the rank ratio of the memory region assigned in the system.

In a step S225, in the OS, the application program is located into the selected memory region for executing. After execution of the application program is completed, the OS can further enter the SMM through an interrupt signal to release the memory region.

In summary, the system may change a mapping method according to a requirement of the application program, so that the OS can freely and dynamically change the mapping of the memory address space, so as to achieve a better system performance. Since the OS can measure a currently optimal mapping of the memory address space, the OS can dynamically re-map the memory regions of the memory address space. In this way, the system can be always maintained to an optimal state, and all of the channels of the sockets can be maintained in a traffic state as far as possible.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for setting a memory address space, suitable for an electronic apparatus, comprising:
obtaining a memory access frequency of an application program under execution of an operating system;
deciding a mapping of a memory region according to the memory access frequency;
using an interrupt signal to execute an interrupt handler routine;
setting the mapping of the memory region according to a memory mapping mode under execution of the interrupt handler routine; and
loading the application program into the memory region for executing in the operating system.

2. The method for setting the memory address space as claimed in claim 1, wherein the step of obtaining the memory access frequency of the application program comprises:
reading a header of the application program to determine whether the application program is executed based on a processor computation or a memory accessing operation or a combination thereof, so as to obtain the memory access frequency.

3. The method for setting the memory address space as claimed in claim 1, wherein the step of obtaining the memory access frequency of the application program comprises:
obtaining the memory access frequency from historical data of the application program.

4. The method for setting the memory address space as claimed in claim 3, further comprising:
recording execution times of activating a memory cycle during each execution of the application program and an execution time thereof;
calculating the memory access frequency according to the execution times and the execution time; and
after execution of the application program is completed, storing the memory access frequency and a global unique identifier (GUID) of the application program as the historical data corresponding to the application program in a parameter memory.

5. The method for setting the memory address space as claimed in claim 1, wherein the step of setting the mapping of the memory region according to the memory mapping mode under execution of the interrupt handler routine comprises:
obtaining the memory region and a related setting of the memory region; and
setting the related setting of the memory region into a chipset register.

6. The method for setting the memory address space as claimed in claim 1, wherein after the step of setting the mapping of the memory region according to the memory mapping mode under execution of the interrupt handler routine, the method further comprises:
generating a memory mapping data.

7. The method for setting the memory address space as claimed in claim 6, wherein the step of loading the application program into the memory region for executing in the operating system comprises:
reading the memory mapping data so as to load the application program to the corresponding memory region.

8. The method for setting the memory address space as claimed in claim 1, wherein the mapping of the memory region is a uniform memory access (UMA) mode or a non-uniform memory access (NUMA) mode.

9. The method for setting the memory address space as claimed in claim 1, further comprising:
providing a system memory physical topology during a power on self test (POST) process, and the system memory physical topology comprising a memory subsystem configuration and a memory topology structure, wherein the memory subsystem configuration records a number of sockets, a number of channels corresponding to each of the sockets, and a number of memory modules corresponding to each of the channels, and the memory topology structure records a relationship among a socket, a central processor thread, a channel, a memory module and a rank.

10. The method for setting the memory address space as claimed in claim 9, wherein under execution of the operating system, the method further comprises:
reading the system memory physical topology.
